(19) United States
(12) Patent Application Publication
(10) Pub. No.: US 2011/0050380 A1
(43) Pub. Date: Mar. 3, 2011

(54) COIL APPARATUS

(75) Inventor: Ryouta NAKANISHI, Saitama (JP)

(73) Assignee: SANKEN ELECTRIC CO., LTD., Saitama-Ken (JP)

(21) Appl. No.: 12/858,788

(22) Filed: Aug. 18, 2010

(30) Foreign Application Priority Data
Aug. 25, 2009 (JP) 2009-194205

(51) Int. Cl. H01F 5/02

(52) U.S. Cl. 336/200

(57) ABSTRACT

A coil apparatus comprising: a core-insertion hole; a plurality of wiring layers including a first wiring layer and a second wiring layer; a coil pattern, which is formed on each of the plurality of wiring layers into a spiral shape around the core-insertion hole, wherein the coil patterns is connected in series and integrated so as to form a single coil formed of laminated wiring layers; and a slit, which divides at least part of each of the coil patterns formed on each of the respective the first wiring layer and the second wiring layer into a plurality of wiring patterns, wherein an outermost wiring pattern on the first wiring layer is connected to an innermost wiring pattern on the second wiring layer, and wherein an innermost wiring pattern on the first wiring layer is connected to an outermost wiring pattern on the second wiring layer.

### CROSS-REFERENCE TO RELATED APPLICATION

This application claims priority from Japanese Patent Application No. 2009-194205 filed on Aug. 25, 2009, the entire subject matter of which is incorporated herein by reference.

### BACKGROUND

1. Technical Field

The present invention relates to a coil apparatus for use in a transformer, an inductor or the like.

2. Description of The Related Art

In order to make a transformer, an inductor, etc., smaller and thinner, a coil apparatus provided in those devices is getting smaller and thinner. In such a coil apparatus, a coil pattern made from a conductive material, such as a copper thin film etc., is formed into spiral shape around a hole for inserting a core on an insulative substrate. In such case, it has been known that eddy current losses are came up in the coil pattern cause to an effect of leakage flux from the core. (see e.g. JP-A-H08-203736).

In the coil apparatus including the core that disclosed in JP-A-H08-203736, a plurality of slits, which extends along a current flowing direction in the spiral conductive pattern on the insulative substrate, is provided in a region where a proximity effect is intensely came up by leakage flux. The slit serves to divide a path of large eddy current caused by leakage flux to prevent large eddy current being generated. The slit also serves to increase a surface area of the coil pattern so as to reduce concentration of current distribution caused by a synergistic action of a skin effect and the proximity effect by eddy current in the coil pattern. The conduction loss in the coil pattern is reduced by the slit provided in the coil pattern.

However, if a slit extending along a current direction is provided in the whole or a part of a coil pattern and is divided into a plurality of wiring patterns (conductive patterns), an inner wiring pattern and an outer wiring pattern are formed and the lengths of the respective wiring patterns become different, so that resistance of the inner wiring pattern becomes lower than that of the outer wiring pattern. Thus, a problem arises that currents do not flow through the respective wiring patterns in the same quantity and greater current flows through the inner wiring pattern.

### SUMMARY

Therefore, the coil apparatus of the invention is objected to balance current flowing through the respective wiring patterns, even if the whole or a part of a coil pattern is divided into a plurality of wiring patterns by a slit extending along current direction

In the invention, A coil apparatus comprising: a core-insertion hole for inserting a core; a plurality of wiring layers including a first wiring layer and a second wiring layer; a coil pattern, which is formed on each of the plurality of wiring layers into a spiral shape around the core-insertion hole, wherein the coil patterns on the each wiring layers is connected in series and integrated so as to form a single coil formed of laminated wiring layers; and a slit, which extends along a current direction, and which divides at least part of each of the coil patterns formed on each of the respective the first wiring layer and the second wiring layer into a plurality of wiring patterns, wherein each of the plurality wiring patterns includes an outermost wiring pattern and an innermost wiring pattern, wherein the second wiring layer is laminated just below the first wiring layer, wherein an outermost wiring pattern on the first wiring layer is connected to an innermost wiring pattern on the second wiring layer, and wherein an innermost wiring pattern on the first wiring layer is connected to an outermost wiring pattern on the second wiring layer.

According to the invention, a coil apparatus capable of balancing respective currents flowing through a plurality of divided wiring patterns is provided.

### BRIEF DESCRIPTION OF DRAWINGS

FIG. 1A is a view showing an array configuration of a wiring pattern formed in each wiring layers in a coil apparatus of a first embodiment, and FIG. 1B is a view showing an connection configuration of a wiring pattern formed in each wiring layers in a coil apparatus of the first embodiment;

FIG. 2A is a view showing an array configuration of a wiring pattern formed in each wiring layers in a coil apparatus of a second embodiment, and FIG. 2B is a view showing an connection configuration of a wiring pattern formed in each wiring layers in a coil apparatus of the second embodiment; and

FIG. 3A is a view showing an array configuration of a wiring pattern formed in each wiring layers in a coil apparatus of a third embodiment, and FIG. 3B is a view showing an connection configuration of a wiring pattern formed in each wiring layers in a coil apparatus of the third embodiment.

### DETAILED DESCRIPTION OF THE PREFERRED EMBODIMENTS

Hereinafter, a coil apparatus according embodiments will be described in detail with reference to the drawings.

### First Embodiment

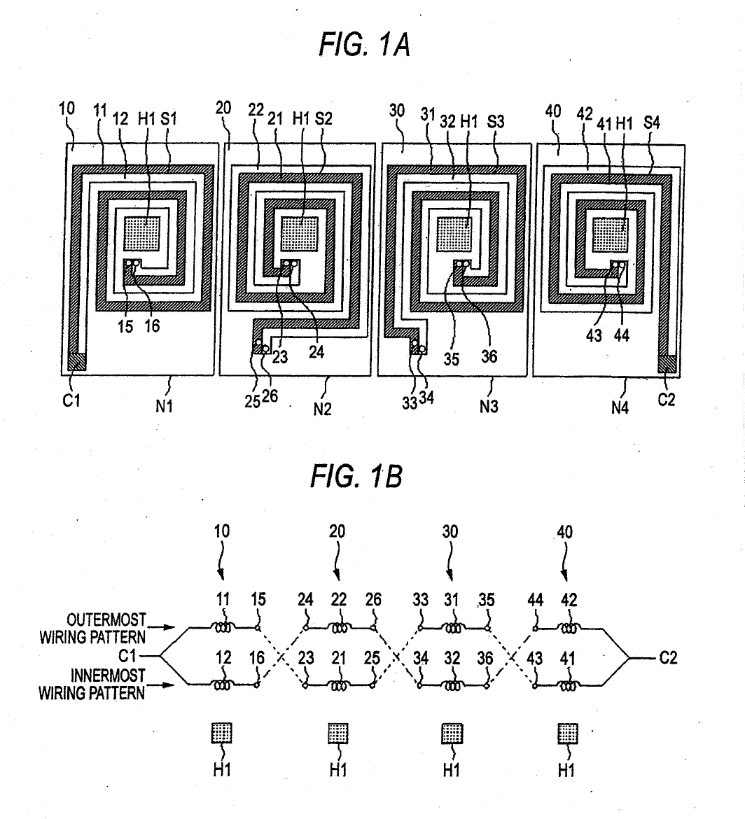

FIG. 1A is a view showing an array configuration of a wiring pattern formed in each wiring layers in a coil apparatus of a first embodiment, and FIG. 1B is a view showing an connection configuration of a wiring pattern formed in each wiring layers in a coil apparatus of the first embodiment. As shown in FIGS. 1A and 1B, the coil apparatus of the first embodiment is configured so that: a coil pattern is formed into spiral shape around a core-insertion hole H1 for inserting a core, on each wiring layers N1 to N4 including a first wiring layer N1, a second wiring layer N2, a third wiring layer N3 and a fourth wiring layer N4; the each wiring layer N1 to N4 are laminated in the order of N1 (an uppermost wiring layer), N2, N3, N4 (a lowest wiring layer) as enumerated from the topside; the coil patterns formed on each wiring layers N1 to N4 are serially connected through a via-hole (which is called as a conduction hole to electrically connect the wiring layers each other); the coil patterns formed on each wiring layers N1 to N4 are combined and make up a single coil. That is, the each wiring layer N1 to N4 is configured so that: the coil pattern made from a conductive material such as a copper thin film, etc., is formed into spiral shape around a core-insertion hole H1 for inserting a core, on an insulative substrate; via-hole is formed on one or both ends of the coil pattern (one or both ends of the divided each wiring patterns).

The coil pattern 10 formed on the first wiring layer N1 is divided into an outermost wiring pattern 11 and an innermost wiring pattern 12 by a slit S1 extending along a current direction so as to have the same widths. The slit S1 is formed in the whole of the coil pattern 10 from one end to another end. One-side ends of the wiring patterns 11, 12 (one end of the coil pattern 10) are connected to a pad C1 and become an end of a coil (a single coil) integrated with the pad C1. Another-side ends of the wiring patterns 11, 12 (another end of the coil pattern 10) have via-holes 15, 16, respectively, to serially connect with respective one-side ends of wiring patterns 21, 22 (one end of a coil pattern 20) formed on the second wiring layer N2 which will be described later.

The coil pattern 20 formed on the second wiring layer N2 is divided into an innermost wiring pattern 21 and an outermost wiring pattern 22 by a slit S2 extending along a current direction so as to have the same widths. The slit S2 is formed in the whole of the coil pattern 20 from one end to another end. One-side ends of the wiring patterns 21, 22 have via-holes 23, 24, respectively, to serially connect with respective another-side ends of the wiring patterns 11, 12 formed on the first wiring layer N1. Another-side ends of the wiring patterns 21, 22 (another end of the coil pattern 20) have via-holes 25, 26, respectively, to serially connect with respective one-side ends of wiring patterns 31, 32 (an end of a coil pattern 30) formed on the third wiring layer N3 which will be described later.

The coil pattern 30 formed on the third wiring layer N3 is divided into an outermost wiring pattern 31 and an innermost wiring pattern 32 by a slit S3 extending along a current direction so as to have the same widths. The slit S3 is formed in the whole of the coil pattern 30 from one end to another end. One-side ends of the wiring patterns 31, 32 have via-holes 33, 34, respectively, to serially connect with respective another-side ends of the wiring patterns 21, 22 formed on the second wiring layer N2. Another-side ends of the wiring patterns 31, 32 (another end of the coil pattern 30) have via-holes 35, 36, respectively, to serially connect with respective one-side ends of wiring patterns 41, 42 (an end of a coil pattern 40) formed on the fourth wiring layer N4 which will be described later.

The coil pattern 40 formed on the fourth wiring layer N4 is divided into an innermost wiring pattern 41 and an outermost wiring pattern 42 by a slit S4 extending along a current direction so as to have the same widths,. The slit S4 is formed in the whole of the coil pattern 40 from one end to another end. One-side ends of the wiring patterns 41, 42 have via-holes 43, 44, respectively, to serially connect with respective another-side ends of the wiring patterns 31, 32 formed on the third wiring layer N3. Another-side ends of the wiring patterns 41, 42 (another end of the coil pattern 40) are connected to a pad C2 and become another end of a coil (a single coil) integrated with the pad C2.

The wiring patterns 11, 21 are serially connected by via-holes 15, 23, the wiring patterns 21, 31 are serially connected by via-holes 25, 33, and the wiring patterns 31, 41 are serially connected to each other by via-holes 35, 43. Thus, the wiring patterns 11, 21, 31,41 are serially connected in the order of an outermost wiring pattern in the first wiring layer N1, an innermost wiring pattern in the second wiring layer N2, an outermost wiring pattern in the third wiring layer N3, and an innermost wiring pattern in the fourth wiring layer N4 as enumerated.

Similarly, the wiring patterns 12, 22 are serially connected by via-holes 16, 24, the wiring patterns 22, 32 are serially connected by via-holes 26, 34, and the wiring patterns 32, 42 are serially connected by via-holes 36, 44. Thus, the wiring patterns 12, 22, 32, 42 are serially connected in the order of an innermost wiring pattern in the first wiring layer N1, an outermost wiring pattern in the second wiring layer N2, an innermost wiring pattern in the third wiring layer N3, and an outermost wiring pattern in the fourth wiring layer N4 as enumerated.

Therefore, since the length L101 of the serially connected wiring patterns 11, 21, 31, 41 becomes equal to the length L102 of the serially connected wiring patterns 12, 22, 32, 42, so that resistance values thereof become equal to each other. Therefore, respective currents flowing through the respective wiring patterns divided into two sections in the wiring layers can be balanced.

That is, current flowing into one end C1 of the coil (single coil) formed by combining the four wiring layers is equally divided into the serially connected wiring patterns 11, 21, 31, 41 and the serially connected wiring patterns 12, 22, 32, 42. And then, the current flows out through another end C2.

According to the coil apparatus of the first embodiment, the whole or a part of the wiring patterns that are formed on the first wiring layer N1 and the second wiring layer N2 placed directly below the first wiring layer N1 is divided into wiring patterns 11, 12 and wiring patterns 21, 22 by the slits S1, S2, respectively. Since the outermost wiring pattern 11 in the first wiring layer N1 is connected to the innermost wiring pattern 21 in the second wiring layer N2, and the innermost wiring pattern 12 in the first wiring layer N1 is connected to the outermost wiring pattern 22 in the second wiring layer N2, respective currents flowing through the wiring patterns 11, 12 and the wiring patterns 21, 22 divided into two sections can be balanced.

In addition, the whole or a part of the wiring patterns that are formed on the fourth wiring layer N4 and the third wiring layer N3 placed directly above the fourth wiring layer N4 is divided into wiring patterns 41, 42 and wiring patterns 31, 32 by the slits S4, S3, respectively. Since the outermost wiring pattern 31 in the third wiring layer N3 is connected to the innermost wiring pattern 41 in the fourth wiring layer N4, and the innermost wiring pattern 32 in the third wiring layer N3 is connected to the outermost wiring pattern 42 in the fourth wiring layer N4, respective currents flowing through the wiring patterns 31, 32 and the wiring patterns 41, 42 divided into two sections can be balanced.

### Second Embodiment

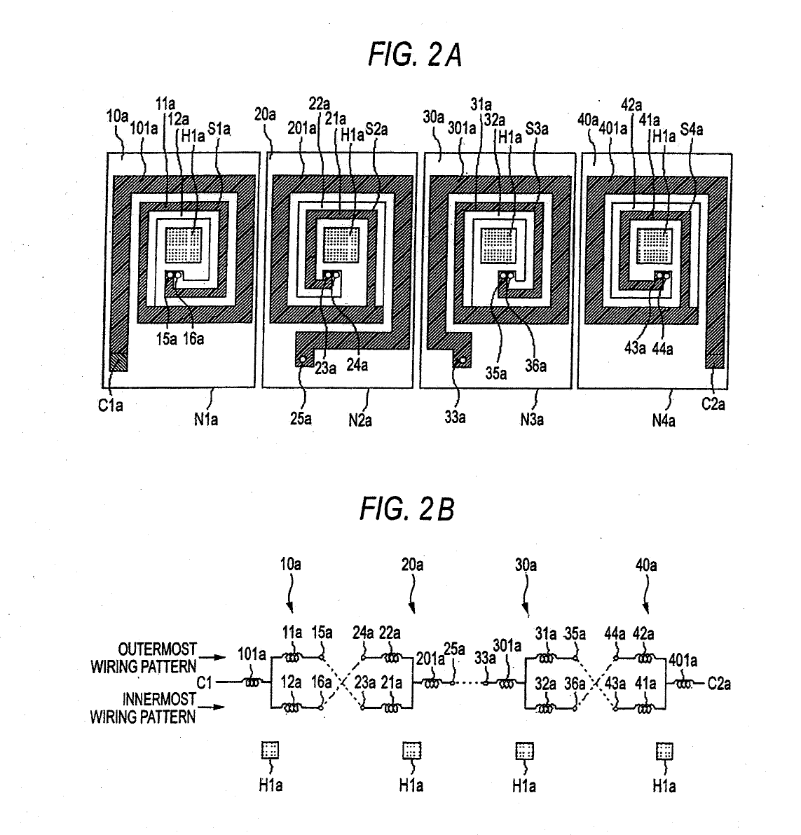

FIG. 2A is a view showing an array configuration of a wiring pattern formed in each wiring layers in a coil apparatus of a second embodiment, and FIG. 2B is a view showing an connection configuration of a wiring pattern formed in each wiring layers in a coil apparatus of the second embodiment. FIGS. 2A and 2B are different from the configuration of the first embodiment shown in FIGS. 1A and 1B. In the FIGS. 1A and 1B, the slit is provided along a current direction in the whole of the coil pattern from one end to another end, on the other hand, in case of the second embodiment, a slit is provided along a current direction in a part of a coil pattern in a region near a core-insertion hole (a region susceptible to leakage flux that leaks from a core).

At a spiraled wiring portion near a core-insertion hole H1a, a coil pattern 10a formed on a first wiring layer N1a is divided into an outermost wiring pattern 11a and an innermost wiring pattern 12a, which have the same widths, by a slit S1a extending along a current direction. One-side ends of the wiring patterns 11a and 12a become another-side ends of an undivided portion 101a of the coil pattern 10a, and one end of the undivided portion 101a of the coil pattern 10a (one end of the coil pattern 10a) is connected to a pad C1 a and become an end of a coil (a single coil) integrated with the pad C1a. Another-side ends of the wiring patterns 11a and 12a (another end of the coil pattern 10a) have via-holes 15a, 16a, respectively, to serially connect with respective one-side ends of wiring patterns 21a, 22a (an end of a coil pattern 20a) formed on a second wiring layer N2a which will be described later.

At a spiraled wiring portion near a core-insertion hole H1a, the coil pattern 20a formed on a second wiring layer N2a is divided into an innermost wiring pattern 21a and an outermost wiring pattern 22a by a slit S2a extending along a current direction, so as to have the same widths. One-side ends of the wiring patterns 21a and 22a have via-holes 23a, 24a, respectively, to serially connect with respective another-side ends of the wiring patterns 11a, 12a formed on the first layer. Another-side ends of the wiring patterns 21a, 22a become one end of an undivided portion 201a of the coil pattern 20a, another end of the undivided portion 201a of the coil pattern 20a (another end of the coil pattern 20a) have a via-hole 25a to serially connect with one end of an undivided portion 301a of a coil pattern 30a formed on a third wiring layer N3a to be described below.

At a spiraled wiring portion near a core-insertion hole H1a, the coil pattern 30a formed on the third wiring layer N3a is divided, into an outermost wiring pattern 31a and an innermost wiring pattern 32a by a slit S3a extending along a current direction so as to have the same widths. One-side ends of the wiring patterns 31a, 32a become another end of an undivided portion 301a of the coil pattern 30a, and one end of the undivided portion 301a of the coil pattern 30a (one end of the coil pattern 30a) has a via-hole 33a to serially connect with another end of the undivided portion 201a of the coil pattern 20a (another end of the coil pattern 20a) formed on the second wiring layer N2a. Another-side ends of the wiring patterns 31a, 32a (another end of the coil pattern 30a) have via-holes 35a, 36a, respectively, to respective serially connect with one-side ends of wiring patterns 41a, 42a formed on a fourth wiring layer N4a to be described below.

At a wiring portion near a core-insertion hole H1a, the coil pattern 40a formed on the fourth wiring layer N4a is divided into an innermost wiring pattern 41a and an outermost wiring pattern 42a by a slit S4a extending along a current direction as to have the same widths. One-side ends of the wiring patterns 41a, 42a have via-holes 43a, 44a, respectively, to serially connect with respective another-side ends of the wiring patterns 31a, 32a formed on the third wiring layer N3a. Another-side ends of the wiring patterns 41a, 42a become one end of an undivided portion 401a of the coil pattern 40a, and another end of the undivided portion 401a of the coil pattern 40a (another end of the coil pattern 40a) is connected to a pad C2a and becomes another end of a coil (a single coil) integrated with the pad C2a.

The wiring patterns 11a, 21a are serially connected to each other by the via-holes 15a, 23a, the coil patterns 20a, 30a are serially connected to each other by the via-holes 25a, 33a , and the wiring patterns 31a, 41a are serially connected to each other by the via-holes 35a, 43a. Thus, the wiring patterns 11a, 21a are serially connected in the order of an outermost wiring pattern in the first wiring layer N1a and an innermost wiring pattern in the second wiring layer N2a. The wiring patterns 31a, 41a are serially connected in the order of an outermost wiring pattern in the third wiring layer N3a and an innermost wiring pattern in the fourth wiring layer N4a.

Similarly, the wiring patterns 12a, 22a are serially connected to each other by the via-holes 16a, 24a, the coil patterns 20a, 30a are serially connected to each other by the via-holes 25a, 33a, and the wiring patterns 32a, 42a are serially connected to each other by the via-holes 36a, 44a. Thus, the wiring patterns 12a, 22a are serially connected in the order of an innermost wiring pattern in the first wiring layer N1a and an outermost wiring pattern in the second wiring layer N2a, and the wiring patterns 32a, 42a are serially connected to each other at places in the order of an innermost wiring pattern in the third wiring layer N3a and an outermost wiring pattern in the fourth wiring layer N4a.

Therefore, the length L201 of the serially connected wiring patterns 11a, 21a becomes equal to the length L202 of the serially connected wiring patterns 12a, 22a, so that resistance values thereof become equal to each other. In addition, the length L203 of the serially connected wiring patterns 31a, 41a becomes equal to the length

L204 of the serially connected wiring patterns 32a, 42a, so that resistance values thereof become equal to each other. Therefore, respective currents flowing through the respective wiring patterns divided into two sections in the wiring layers can be balanced.

That is, current flowing into one end C1a of the coil (single coil) formed by combining the four wiring layers is equally divided into the serially connected wiring patterns 11a, 21a and the serially connected wiring patterns 12a, 22a respectively, and similarly equally divided into the wiring patterns 31a, 41a and the wiring patterns 32a, 42a, respectively. And then, the current flows out through another end C2a.

According to the coil apparatus of the second embodiment, the same effect as the first embodiment can be obtained.

### Third Embodiment

In the first embodiment, the coil pattern formed on the respective wiring layers is divided into a plurality of sub-coil patterns. As a result, as the number of the wiring layers (the number of stacked layers) increases, the number of the via-holes also increases. When the number of the via-holes increases, a region where the wiring patterns can be formed may be reduced, so that the wiring length of the wiring pattern may become longer.

According to a third embodiment, a coil pattern in a surface-side wiring layer that is susceptible to leakage flux that leaks from a core is divided into a plurality of wiring patterns. A coil pattern in an intermediate wiring layer that is not susceptible to leakage flux that leaks from a core is not divided into sub-wiring patterns and is provided as one wiring pattern (single coil pattern).

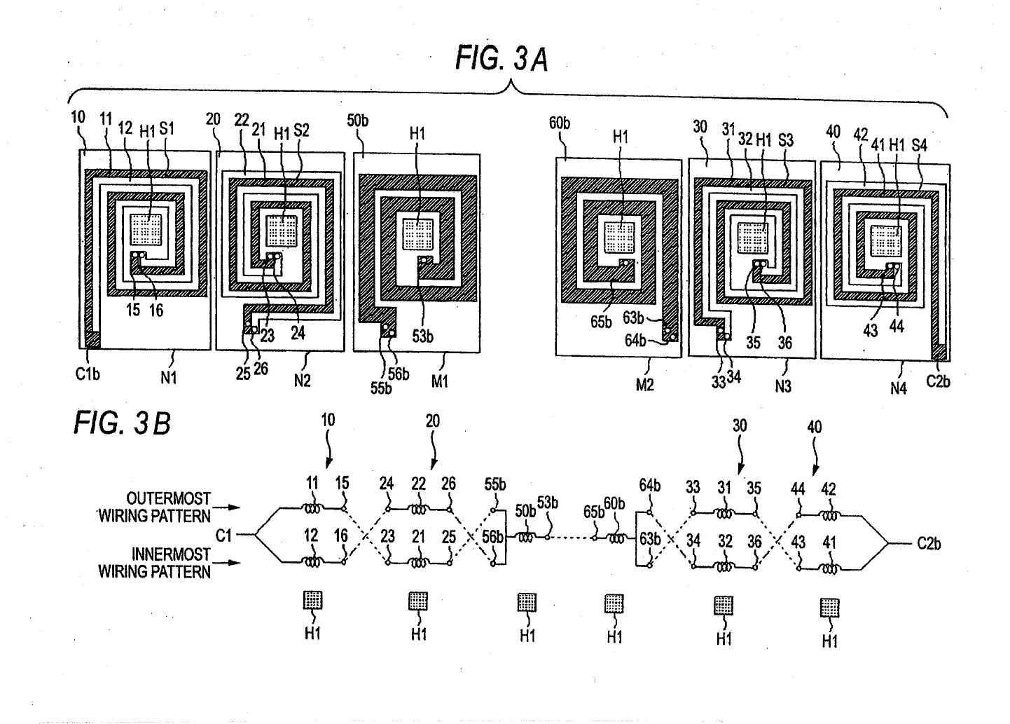

FIG. 3A is a view showing an array configuration of a wiring pattern formed in each wiring layers in a coil apparatus of a third embodiment, and FIG. 3B is a view showing an connection configuration of a wiring pattern formed in each wiring layers in a coil apparatus of the third embodiment. In FIGS. 3A and 3B, parts identical to the first embodiment shown in FIGS. 1A and 1B are designated as the same reference signs as the first embodiment, and the description thereof will be omitted. The FIGS. 3A and 3B are different from the first embodiment of FIGS. 1A and 1B. In the FIGS. 3A and 3B, two wiring layers are provided between the second wiring layer N2 and the third wiring layer N3. The two wiring layers M1, M2 include a single wiring pattern 50b, 60b, respectively, that is not divided into wiring patterns.

That is, as shown in FIGS. 3A and 3B, a coil apparatus of the third embodiment includes a single coil pattern that is not divided coil patterns. The single coil patterns are formed on one or more wiring layers, which are disposed below the second wiring layer N2 provided just below the first wiring layer (the uppermost wiring layer) N1, and which are disposed above the third wiring layer N3 provided just above the fourth wiring layer (lowermost wiring layer) N4.

Further, in an end portion of the coil patterns formed on the each wiring layers M1, M2 that are not susceptible to leakage flux leaking from a core, it is possible to serially connect the coil patterns formed on the respective wiring layers M1, M2 by at least one via-hole. Thus, in case that the number of the wiring layers (the number of laminated layers) is equal to that in the first embodiment, the number of the via-holes in the third embodiment becomes smaller than that in the first embodiment.

Thus, a region where the wiring pattern can be formed becomes wider, so that it is prevented that the wiring length of the wiring pattern becomes longer.

According to the coil apparatus of the third embodiment in the present invention, the same effect as the first embodiment can be obtained.

In addition, the first embodiment and second embodiment has been described that the whole or a part of the coil pattern is divided into two wiring patterns, which have the same width, by a single slit. But the invention is not limited thereto and may also have other configuration that the whole or a part of the coil pattern is divided into a plurality of wiring patterns by a plurality of slits.

For instance, in case that the whole or a part of a coil pattern is divided into three wiring patterns, which have the same width, by two slits, an outermost wiring pattern on a first wiring layer is serially connected to an innermost wiring pattern on a second wiring layer through a via-hole, an innermost wiring pattern on the second wiring layer is serially connected to an outermost wiring pattern on a third wiring layer through a via-hole, and an outermost wiring pattern on the third wiring layer is serially connected to an innermost wiring pattern on a fourth wiring layer through a via-hole (a first type of serial connecting wiring pattern).

Further, an intermediate wiring pattern on the first wiring layer is serially connected to an intermediate wiring pattern on the second wiring layer through a via-hole, the intermediate wiring pattern on the second wiring layer is serially connected to an intermediate wiring pattern on the third wiring layer through a via-hole, and the intermediate wiring pattern on the third wiring layer is serially connected to an intermediate wiring pattern on the fourth wiring layer through a via-hole (a second type of serial connecting wiring pattern).

Furthermore, an innermost wiring pattern on the first wiring layer is serially connected to an outermost wiring pattern on the second wiring layer through a via-hole, the outermost wiring pattern on the second wiring layer is serially connected to an innermost wiring pattern on the third wiring layer through a via-hole, and the innermost wiring pattern on the third wiring layer is serially connected to an outermost wiring pattern on the fourth wiring layer through a via-hole (a third type of serial connecting wiring pattern).

Therefore, the lengths L401, L402 and L403 of the first, second, third types of serial connecting wiring patterns become equal to each other, so that resistance values thereof become equal to each other, and so that respective currents flowing through the wiring patterns divided into three sections can be balanced.

The first and second embodiments have been described that are adapted to four-layered wiring layers. But the invention is not limited thereto and may also be adapted to wiring layer including an even number of layers. For instance, in case of two-layered wiring layers, it may be configured so that a third wiring layer N3 (N3a) and a fourth wiring layer N4 (N4a) are omitted.

The coil apparatus of the invention is applicable to a coil apparatus such as a transformer, an inductor or the like which requires to be made smaller and thinner.

What is claimed is:

1. A coil apparatus comprising:
a core-insertion hole for inserting a core;
a plurality of wiring layers including a first wiring layer and a second wiring layer;
a coil pattern, which is formed on each of the plurality of wiring layers into a spiral shape around the core-insertion hole, wherein the coil patterns on the each wiring layers is connected in series and integrated so as to form a single coil formed of laminated wiring layers; and
a slit, which extends along a current direction, and which divides at least part of each of the coil patterns formed on each of the respective the first wiring layer and the second wiring layer into a plurality of wiring patterns,
wherein each of the plurality wiring patterns includes an outermost wiring pattern and an innermost wiring pattern,
wherein the second wiring layer is laminated just below the first wiring layer,
wherein an outermost wiring pattern on the first wiring layer is connected to an innermost wiring pattern on the second wiring layer, and
wherein an innermost wiring pattern on the first wiring layer is connected to an outermost wiring pattern on the second wiring layer.

2. The coil apparatus according to claim 1, further comprising:
a third wiring layer provided below the second wiring layer; and
a fourth wiring layer provided below the second wiring layer,
wherein the third wiring layer is laminated just above the forth wiring layer,
wherein at least part of each of the coil patterns formed on the respective the third wiring layer and fourth wiring layer is divided into a plurality of wiring patterns by the slit,
wherein an outermost wiring pattern on the third wiring layer is connected to an innermost wiring pattern on the fourth wiring layer, and
wherein an innermost wiring pattern on the third wiring layer is connected to an outermost wiring pattern on the fourth wiring layer.

3. The coil apparatus according to claim 2, further comprising:
one or more additional wiring layers, which are disposed below the second wiring layer and disposed above the third wiring layer,
wherein a coil pattern formed on the one or more additional wiring layers is not divided into a plurality of wiring patterns.

4. The coil apparatus according to claim 2,
wherein the outermost wiring pattern on the second wiring layer is connected to the innermost wiring pattern on the third wiring layer, and
wherein the innermost wiring pattern on the second wiring layer is connected to the outermost wiring pattern on the third wiring layer.

5. The coil apparatus according to claim 2,
wherein the slit divides the coil patterns in a region near the core-insertion hole, and
wherein a non-divided coil pattern on the second wiring layer is connected to a non-divided coil pattern on the third wiring layer.

6. The coil apparatus according to claim 2,
wherein the wiring patterns on the first wiring layer are connected to the wiring patterns on the second wiring layer at a first position,
wherein the wiring patterns on the first wiring layer are connected to the wiring patterns on the forth wiring layer at a second position, and
wherein the first position is not overlap with the second position in a laminate direction.
